(19) United States
(12) Patent Application Publication
(10) Pub. No.: US 2023/0337134 A1
(43) Pub. Date: Oct. 19, 2023

(54) METHOD FOR DATA TRANSMISSION, COMMUNICATION APPARATUS, AND STORAGE MEDIUM

(71) Applicant: SPREADTRUM COMMUNICATIONS (SHANGHAI) CO., LTD., Shanghai (CN)

(72) Inventors: Huayu ZHOU, Shanghai (CN); Mimi CHEN, Shanghai (CN); Zhenzhu LEI, Shanghai (CN); Zhengang PAN, Shanghai (CN)

(21) Appl. No.: 18/027,820

(22) PCT Filed: Aug. 25, 2021
(86) PCT No.: PCT/CN2021/114525

§ 371 Date: Mar. 22, 2023

(30) Foreign Application Priority Data
Sep. 22, 2020 (CN) 202010999499.7

(51) Int. Cl. H04W 52/02

(52) U.S. Cl. CPC H04W 52/0229

(57) ABSTRACT

A method for data transmission, a communication apparatus, and a storage medium are provided. The method includes: switching from a sleep state to a working state in response to detecting that a header of a symbol of a first type is a predefined sequence or signaling.

### CROSS-REFERENCE TO RELATED APPLICATION(S)

This application is a National Stage of International Application No. PCT/CN2021/114525, field Aug. 25, 2021, which claims priority to Chinese Patent Application No. 202010999499.7, filed Sep. 22, 2020, the disclosures of which are hereby incorporated by reference in their entirety.

### TECHNICAL FIELD

The disclosure relates to the field of communication technologies, and more particularly, to a method for data transmission, a communication apparatus, and a storage medium.

### BACKGROUND

In the evolution of communication systems, radio waves are well applied for wireless communication technologies at this stage.

At present, in the 5th-generation (5G) new radio (NR) system, the terminal may continuously perform blind detection on a control channel to determine whether to wake up from the sleep state to receive on a specified time-frequency resource data information transmitted by the access network device. This is because in unlicensed spectrum and shared spectrum scenarios, the base station transmits data information opportunistically. The base station can only occupy a current channel for a short period of time after transmitting the data information, and then needs to release the channel, so that the channel can be used for other spectrum, thereby ensuring fairness. However, the terminal device continuously performs blind detection on the control channel, which will waste a lot of power consumption.

### SUMMARY

In a first aspect, implementations of the disclosure provide a method for data transmission. The method includes: switching from a sleep state to a working state in response to detecting that a header of a symbol of a first type is a predefined sequence or signaling.

In a second aspect, implementations of the disclosure provide a communication apparatus. The apparatus includes a processor, a memory, and a user interface. The processor, the memory, and the user interface are coupled with one another. The memory is configured to store computer programs. The computer programs include program instructions. The processor is configured to invoke the program instructions to perform the method for data transmission as described in the first aspect.

In a third aspect, implementations of the disclosure provide a computer-readable storage medium. The computer-readable storage medium stores one or more instructions. The one or more instructions are configured to be loaded and executed by a processor to perform the method for data transmission as described in the first aspect.

### BRIEF DESCRIPTION OF THE DRAWINGS

To describe technical solutions of implementations of the disclosure more clearly, the following briefly introduces the drawings required for the description of implementations. Apparently, the drawings in the following description are some implementations of the disclosure. Those of ordinary skill in the art may also obtain other drawings based on these drawings without creative efforts.

FIG. 1 is a schematic diagram illustrating a network architecture for a method for symbol application provided in implementations of the disclosure.

FIG. 2 is a schematic flowchart illustrating a method for data transmission provided in implementations of the disclosure.

FIG. 3 is a schematic structural diagram illustrating a symbol of a first type in forward order provided in implementations of the disclosure.

FIG. 4 is a schematic structural diagram illustrating a symbol of a first type in backward order provided in implementations of the disclosure.

FIG. 5 is a schematic flowchart illustrating another method for data transmission provided in implementations of the disclosure.

FIG. 6 is a schematic diagram illustrating units of a communication apparatus provided in implementations of the disclosure.

FIG. 7 is a simplified schematic diagram illustrating a physical structure of a communication apparatus provided in implementations of the disclosure.

### DETAILED DESCRIPTION

Reference will now be made in detail to exemplary implementations, examples of which are illustrated in accompanying drawings. When the following description refers to the accompanying drawings, the same numerals in different drawings refer to the same or similar elements unless otherwise indicated. Implementation manners described in following exemplary implementations do not represent all implementations consistent with the disclosure, but rather are merely examples of terminals and methods consistent with aspects of the disclosure as detailed in appended claims.

It should be noted that, in the disclosure, the term “comprising”, “including”, or any other variation thereof is intended to cover a non-exclusive inclusion such that a process, a method, an object, or an apparatus including a set of elements includes not only those elements, but also other elements not expressly listed or elements inherent in the process, the method, the object, or the apparatus. Without further limitations, an element defined by the phrase “including a . . . ” does not exclude the existence of other identical elements in the process, the method, the object, or the apparatus including the element. In addition, components, features, and elements with the same name in different implementations of the disclosure may have the same meaning, or may have different meanings, and their specific meanings need to be determined by their explanations in specific implementations or further combined with the context of the specific implementations.

It should be understood that although the terms “first”, “second”, “third”, and the like may be used herein to describe various information, the information should not be limited to these terms. These terms are only used to distinguish information of the same type from one another. For example, without departing from the scope of the disclosure, the first information may also be referred to as the second information. Similarly, the second information may also be referred to as the first information. Depending on the context, the word “if” as used herein may be interpreted as “when” or “in response to determining that”. Furthermore, as used herein, the singular forms “a”, “an”, and “the” are intended to include the plural forms as well, unless the context indicates otherwise. It should be further understood that the terms “comprising” and “including” indicate the existence of stated features, steps, operations, elements, components, items, species, and/or groups, but do not exclude the existence, occurrence, or addition of one or more other features, steps, operations, elements, components, items, species, and/or groups. The terms “or” and “and/or” as used herein are to be construed as inclusive, or to mean either one or any combination. Thus, “A, B, or C” or “A, B, and/or C” means any of: “A”, “B”, “C”, “A and B”, “A and C”, “B and C”, or “A, B, and C”. Exceptions to this definition will only arise when combinations of elements, functions, steps, or operations are inherently mutually exclusive in some way.

It should be understood that although various steps in the flowchart in implementations of the disclosure are displayed sequentially as indicated by arrows, these steps are not necessarily executed sequentially in the order indicated by the arrows. Unless otherwise specified herein, there is no strict order restriction on the execution of these steps, and these steps can be executed in other orders. Moreover, at least some of the steps in the drawings may include multiple sub-steps or stages, these sub-steps or stages are not necessarily executed at the same time, but may be executed at different times, and are not necessarily performed sequentially, but may be performed alternately with at least some of other steps or sub-steps or stages of the steps.

It should be noted that, step numbers such as 210 and 220 are used herein to describe corresponding content more clearly and concisely, and do not constitute a substantive limitation on the order. Those skilled in the art may perform 220 first and then 210 and the like during specific implementation, but all of these shall fall within the scope of the disclosure.

To better understand implementations of the disclosure, technical terms involved in implementations of the disclosure will be introduced below.

Discrete Fourier transform spreading orthogonal frequency division multiplexing (DFT-S-OFDM): a single-carrier modulation scheme, which has a smaller peak-to-average power ratio (PAR) compared with traditional orthogonal frequency division multiplexing (OFDM). DFT-S-OFDM is adopted as an uplink (UL) modulation scheme for long-term evolution (LTE).

Cyclic prefix (CP): a cyclic structure formed by replicating a piece of data following a data symbol to the front of the symbol, so as to ensure that a OFDM signal with a latency always has an integer number of periods in a fast Fourier transform (FFT) integration period. The CP is formed by replicating the signal at the end of the OFDM symbol to the header. There are mainly two types of CP, i.e., normal CP and extended CP. The length of the normal CP is 4.7 μs, and the length of the extended CP is 16.67 μs. The CP can be correlated with other multipath component information to obtain complete information. In addition, the CP can realize time pre-estimation and frequency synchronization.

Unique word (UW) DFT-S-OFDM: a DFT-S-OFDM without CP, which can reduce the transmitter structure of UW DFT-S-OFDM. Similar to the transmitter structure of DFT-S-OFDM, the transmitter structure of UW DFT-S-OFDM also includes a discrete Fourier transform (DFT) module, a subcarrier mapping module, and an inverse fast Fourier transform (IFFT) module, but is different from the transmitter structure of DFT-S-OFDM in the following two aspects. 1) In the UW-DFT-S-OFDM transmitter, a predefined sequence is inserted between a header and a tail of the input of the DFT module, that is, the input of the DFT module includes the header, a data portion, and the tail in sequence, which is different from the traditional DFT-S-OFDM transmitter. In the DFT-S-OFDM transmitter, the input of the DFT module only includes the data portion. Since the input of the DFT module includes the header, the data portion, and the tail in sequence, a symbol also includes the header, the data portion, and the tail in sequence in the time domain. 2) There is no CP in the UW DFT-S-OFDM waveform. Therefore, the UW DFT-S-OFDM waveform usually includes more symbols in one slot or time interval than the DFT-S-OFDM waveform. For example, for the DFT-S-OFDM waveform, there are 14 symbols in one slot or time interval, and for the UW DFT-S-OFDM waveform, there are 15 symbols in one slot or time interval. In the UW DFT-S-OFDM waveform, there is usually one symbol (referred to as reference signal symbol herein) dedicated to a reference signal (RS) or a pilot and used for the receiver to perform channel estimation in the frequency domain and estimate a channel response in the frequency domain. For a reference signal symbol, the data portion is also a predefined sequence which forms a long predefined sequence with predefined sequences of the header and the tail. For other symbols other than the reference signal symbol, predefined sequences of the header and the tail of the symbol are also parts of a long predefined sequence. For each symbol, the header and the tail may be different and configurable. The header of each symbol can be used to reduce inter-symbol interference (ISI). For other symbols other than the reference signal symbol, the tail can be used to update a channel estimation value and estimate a change of the channel response caused by time variation.

Zero tail (ZT) DFT-S-OFDM: another DFT-S-OFDM without CP, which can be considered as a variant of the UW DFT-S-OFDM. In the ZT DFT-S-OFDM transmitter, the header and the tail of the input of the DFT module are sequences of zeros. The ZT DFT-S-OFDM is equivalent to a special form of the UW DFT-S-OFDM.

To better understand implementations of the disclosure, a network architecture applicable in implementations of the disclosure will be described below.

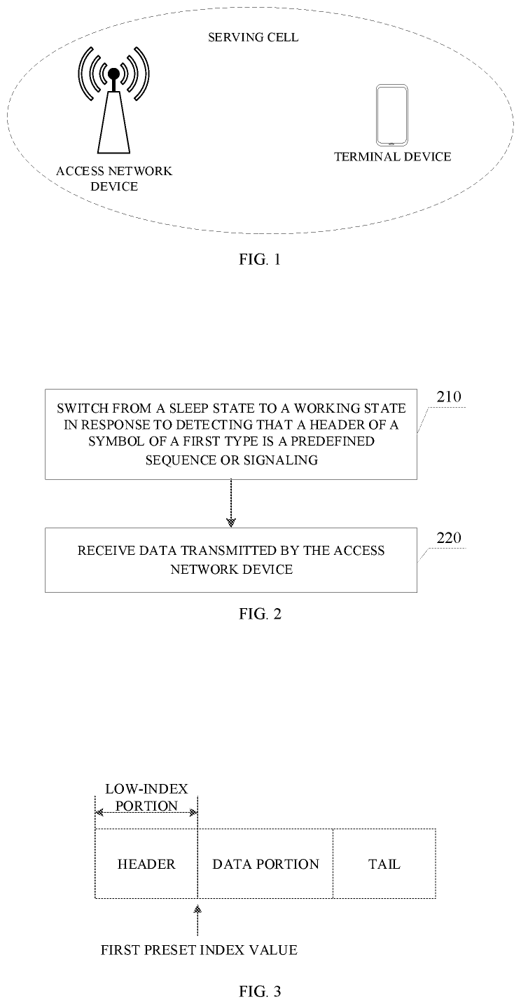

Referring to FIG. 1, FIG. 1 is a schematic diagram illustrating a network architecture for a method for symbol application provided in implementations of the disclosure. As illustrated in FIG. 1, the network architecture may include an access network device and a terminal device. The terminal device establishes a connection with the access network device via a serving cell. There may be one or more channels, such as a physical downlink control channel (PDCCH), a physical downlink shared channel (PDSCH), a physical uplink shared channel (PUSCH), and the like in the serving cell to function as a data transmission medium between the access network device and the terminal device.

The access network device involved in implementations of the disclosure is a network-side entity configured to transmit or receive signals. The access network device may be configured to convert a received air frame to an internet protocol (IP) packet and vice versa, or function as a router between the terminal device and the rest of the access network, where the rest of the access network may include an IP network, etc. The access network device can also coordinate attribute management for air interfaces. For example, the access network device may be an eNB in LTE, a new radio (NR) controller, a gNB in a 5th-generation (5G) system, a centralized unit, an NR base station, a radio remote module, a micro base station, a relay, a distributed unit, a transmission reception point (TRP), a transmission point (TP), or any other radio access device, which is not limited herein.

The terminal device involved in implementations of the disclosure is a user-side entity configured to receive or transmit signals. The terminal device may be a device that provides voice and/or data connectivity to a user, for example, a handheld device, a vehicle-mounted device, and the like with a wireless connection function. The terminal device may also be other processing devices connected to a wireless modem. The terminal device can communicate with a radio access network (RAN). The terminal device may also be referred to as a wireless terminal, a subscriber unit, a subscriber station, a mobile station, a mobile, a remote station, an access point, a remote terminal, an access terminal, a user terminal, a user agent, a user device, or user equipment (UE), etc. The terminal device may be a mobile terminal, such as a mobile phone (or referred to as a “cellular” phone) or a computer equipped with a mobile terminal, such as portable, pocket, handheld, built-in computer, or vehicle-mounted mobile apparatuses, which exchange language and/or data with RANs. For example, the terminal device may also be a personal communication service (PCS) phone, a cordless phone, a session initiation protocol (SIP) phone, a wireless local loop (WLL) station, a personal digital assistant (PDA), etc. Common terminal devices include, for example, mobile phones, tablet computers, notebook computers, handheld computers, mobile Internet devices (MID), vehicles, roadside devices, aircrafts, wearable devices, such as smart watches, smart bracelets, and pedometers, etc., which is not limited herein. Communication methods and related devices provided in the disclosure are introduced in detail below.

In the current technology, the terminal device determines whether to wake up from the sleep state to receive data information transmitted by the access network device by performing blind detection on a control signaling. However, the terminal device may waste a lot of power consumption on the blind detection of the control signaling and the maintenance of synchronization with the network side.

To reduce the power consumption of data transmission and improve the efficiency of data transmission, implementations of the disclosure provide a method for data transmission and a communication apparatus. The method for data transmission and the communication apparatus provided in implementations of the disclosure will be further introduced in detail below.

Referring to FIG. 2, FIG. 2 is a schematic flowchart illustrating a method for data transmission provided in implementations of the disclosure. The flowchart illustrated in FIG. 2 may include the following.

210. Switch from a sleep state to a working state in response to detecting that a header of a symbol of a first type is a predefined sequence or signaling.

After detecting that the header of the symbol of the first type is the predefined sequence or signaling, the terminal device can determine that the access network device has data traffic to be transmitted to the terminal device. Therefore, the terminal device can switch from the sleep state to the working state to receive information transmitted by the access network device on a specified time-frequency resource. The symbol of the first type may be a certain kind of symbol specified by the terminal device or the access network device. The predefined sequence or signaling may be set by the terminal device or the access network device, and can be used as an identifier which indicates that the access network device has data to be transmitted. The terminal device may determine that the access network device has data to be transmitted when detecting that the header of the symbol of the first type is the identifier. When the predefined signaling is adopted, the predefined signaling needs to be simple enough so that the terminal device can determine or obtain the predefined signaling with a relatively small blind detection complexity.

In possible implementations, the terminal device may also determine whether to switch from the sleep state to the working state by detecting an initial signal.

In possible implementations, the symbol of the first type may have a UW DFT-S-OFDM waveform or a ZT DFT-S-OFDM waveform.

In possible implementations, the symbol of the first type may contain a reference signal (RS), a pilot, or a preamble.

In possible implementations, the header of the symbol of the first type may contain an RS, a pilot, or a preamble. In possible implementations, a position of the symbol of the first type may be specified by a signaling. The signaling may be contained in a radio resource control (RRC) signaling, a medium access control (MAC) signaling, a MAC packet data unit (PDU), a MAC control element (CE), a PDCCH, downlink control information (DCI), or a slot format indicator (SFI).

In possible implementations, the header of the symbol of the first type is longer than a header of a symbol other than the symbol of the first type. It can be understood that the predefined sequence is longer than the header of other symbols. This is the difference. The terminal device may take the length of the header of the symbol as one condition for determining whether the header of the symbol is the predefined sequence.

In possible implementations, the header of the symbol of the first type is a low-index portion of an input of a DFT module. As illustrated in FIG. 3, when the input of the DFT module is in forward order, that is, indexes of the input of the DFT module are in ascending order, such as 1, 2, 3, . . . , the low-index portion of the input of the DFT module may be the header of the symbol of the first type.

In possible implementations, the header of the symbol of the first type is a portion of the input of the DFT module indicated by an index with a value less than a first predefined index value. As illustrated in FIG. 3, when the input of the DFT module is in forward order, the portion indicated by the index with a value less than the first predefined index value is the header of the symbol of the first type, and a portion indicated by an index with a value greater than the first predefined index value is a data portion or a tail. The first predefined index value may be configured by the terminal device or the access network device.

In possible implementations, the header of the symbol of the first type is prior to a data portion of the symbol of the first type. As illustrated in FIG. 3, when the input of the DFT module is in forward order, the structure of the symbol of the first type from left to right is the header, the data portion, and the tail, and a portion prior to the data portion is the header of the symbol of the first type.

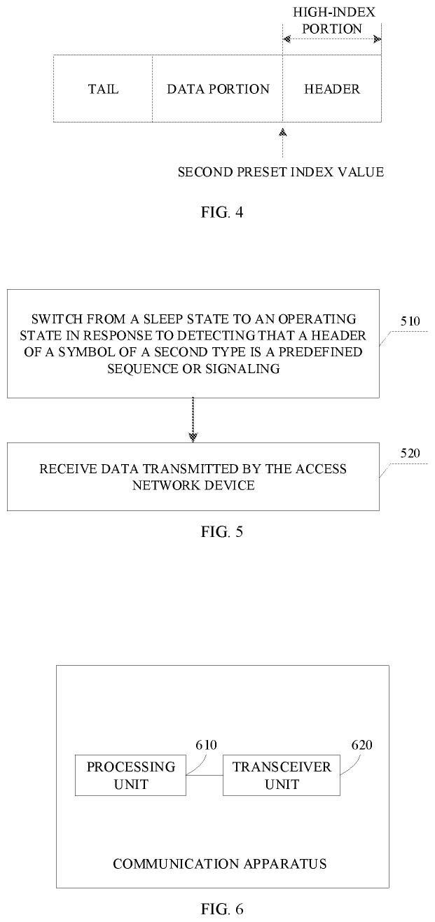

In possible implementations, the header of the symbol of the first type is a high-index portion of an input of a DFT module. As illustrated in FIG. 4, when the input of the DFT module is in backward order, that is, indexes of the input of the DFT module are in descending order, such as 100, 99, 98, . . . , the high-index portion of the input of the DFT module may be the header of the symbol of the first type.

In possible implementations, the header of the symbol of the first type is a portion of the input of the DFT module indicated by an index with a value greater than a second predefined index value. As illustrated in FIG. 4, when the input of the DFT module is in backward order, the portion indicated by the index with a value greater than the second predefined index value is the header of the symbol of the first type, and a portion indicated by an index with a value less than the second predefined index value is a data portion or a tail. The second predefined index value may be configured by the terminal device or the access network device.

In possible implementations, the header of the symbol of the first type is subsequent to a data portion of the symbol of the first type. As illustrated in FIG. 4, when the input of the DFT module is in backward order, the structure of the symbol of the first type from left to right is the tail, the data portion, and the header, and a portion subsequent to the data portion is the header of the symbol of the first type.

220. Receive data transmitted by the access network device.

After switching from the sleep state to the working state, the terminal device can detect a control channel, where detecting the control channel means that the terminal device has successfully switched from the sleep state to the working state. The control channel may include a PDCCH, a PDCCH of at least one DCI format, or a PDCCH of at least one search space set. For example, the terminal device may detect downlink (DL) scheduling information on the PDCCH, so as to receive corresponding data on a time-frequency resource indicated by the DL scheduling information.

In possible implementations, after switching from the sleep state to the working state, the terminal device can start a timer, where starting the timer means that the terminal device has successfully switched from the sleep state to the working state. The timer may be a timer within a duration of the working state, or an inactivity timer (InactivityTimer). The timer within the duration of the working state may be a timer that is started once the terminal device enters the working state, and a running period of the timer is a period when the terminal device is in the working state. The inactivity timer may be started or restarted once the terminal device receives a control signaling of hybrid automatic repeat request (HARQ) initial retransmission during monitoring the control channel. Before the inactivity timer expires, the terminal device can continuously monitor the control channel. This means that if the header of the symbol of the first type is the predefined sequence or signaling, the predefined sequence may indicate the terminal device to start the inactivity timer.

According to implementations of the disclosure, the terminal device can determine that there is data to be transmitted by the access network device and to be received by the terminal device when detecting that the header of the symbol of the first type is the predefined sequence or signaling. Then, the terminal device can switch from the sleep state to the working state. The terminal device can receive on a corresponding time-frequency resource the data transmitted by the access network device according to the scheduling information obtained in the working state. In this way, instead of continuously performing blind detection on the control channel, the terminal device determines whether to switch from the sleep state to the working state according to whether the header of the symbol of the first type is the predefined sequence or signaling, thereby greatly saving the power consumption of the terminal device.

Referring to FIG. 5, FIG. 5 is a schematic flowchart illustrating another method for data transmission provided in implementations of the disclosure. The flowchart illustrated in FIG. 5 may include the following.

510. Switch from a sleep state to a working state in response to detecting that a header of a symbol of a second type is a predefined sequence or signaling.

In possible implementations, for some scenarios, the access network device can set the header of the symbol of the second type as a zero sequence, a zero-power sequence, or a low-power sequence, then the symbol of the second type can reserve a period of low transmission power in the time domain. In the period of low transmission power, the access network device may transmit some signals of different systems or different waveforms. The symbol of the second type may be a certain kind of symbol specified by the terminal device or the access network device. The access network device can add some signals of different systems or different waveforms to the header of the symbol of the second type that has been set by the terminal device as the zero sequence, the zero-power sequence, or the low-power sequence, thereby ensuring the coexistence of different systems. The coexistence means that if the header of the symbol of the second type is the predefined sequence or signaling which can be recognized by different systems, the header of the symbol of the second type can be mutually recognized by different systems and coexist in different systems.

It should be noted that the terminal device may also assume that the header of the symbol of the second type is the zero sequence, the zero-power sequence, or the low-power sequence. That is, even if the header of the symbol of the second type is not the zero sequence, the zero-power sequence, or the low-power sequence, the terminal device can assume that the header of the symbol of the second type is the zero sequence, the zero-power sequence, or the low-power sequence. In this way, the access network device can also add other signals when transmitting the header of the symbol of the second type.

In possible implementations, a portion of the symbol of the second type other than the header may have a UW DFT-S-OFDM waveform or a ZT DFT-S-OFDM waveform.

In possible implementations, the header of the symbol of the second type may have a waveform other than the UW DFT-S-OFDM waveform or the ZT DFT-S-OFDM waveform.

In possible implementations, the symbol of the second type may have a waveform other than the UW DFT-S-OFDM waveform or the ZT DFT-S-OFDM waveform. In this case, the access network device may add other signals, such as a common preamble to the position of the entire symbol of the second type.

In possible implementations, the symbol of the second type may contain an RS, a pilot, or a preamble.

In possible implementations, the header of the symbol of the second type may contain an RS, a pilot, or a preamble. In possible implementations, a position of the symbol of the second type may be specified by a signaling. The signaling may be contained in an RRC signaling, a MAC signaling, a MAC PDU, a MAC CE, a PDCCH, a DCI, or an SFI.

In possible implementations, the header of the symbol of the second type is longer than a header of a symbol other than the symbol of the second type.

The terminal device can detect the predefined sequence or signaling in the header of the symbol of the second type. The predefined sequence or signaling is information added by the access network device to the header of the symbol of the second type. For example, the terminal device assumes that the header of the symbol of the second type is the zero sequence, then the access network device may add a common preamble to the header of the symbol of the second type when transmitting the header of the symbol of the second type. The terminal device can detect the common preamble in the header of the symbol of the second type, so that the terminal can confirm whether the common preamble is received.

In possible implementations, the symbol of the second type may contain a common preamble.

In possible implementations, the header of the symbol of the second type may contain a common preamble.

520. Receive data transmitted by the access network device.

After determining that the header of the symbol of the second type is the predefined sequence or signaling, the terminal device switches from the sleep state to the working state, and then can receive data information transmitted by the access network device. The manner of receiving the data information transmitted by the access network device is introduced in detail in step 220 of above implementations, which will not be repeated herein.

According to implementations of the disclosure, the terminal device can assume that the header of the symbol of the second type is the zero sequence, the zero-power sequence, or the low-power sequence, so that when transmitting the header of the symbol of the second type, the access network device is in the period of low transmission power. In this way, the access network device can add some signals of different systems or different waveforms to the header of the symbol of the second type when transmitting the header of the symbol of the second type, thereby ensuring the coexistence of different systems. In addition, the terminal device switches from the sleep state to the working state in response to detecting that the header of the symbol of the second type is the predefined sequence or signaling, thereby also reducing the power consumption of data transmission.

Referring to FIG. 6, FIG. 6 is a schematic diagram illustrating units of a communication apparatus provided in implementations of the disclosure. The communication apparatus illustrated in FIG. 3 may be configured to perform some or all functions of the terminal device in foregoing method implementations illustrated in FIGS. 2 and 5. The apparatus may be a terminal device, an apparatus in the terminal device, or an apparatus that can be used with the terminal device. The logical structure of the apparatus may include a processing unit 610 and a transceiver unit 620. When being applied to a method for data transmission, the communication apparatus may include the following. The processing unit 610 is configured to switch from a sleep state to a working state in response to detecting that a header of a symbol of a first type is a predefined sequence or signaling.

In possible implementations, the symbol of the first type has a UW DFT-S-OFDM waveform or a ZT DFT-S-OFDM waveform, and the transceiver unit 620 is configured to receive the symbol of the first type.

In possible implementations, the symbol of the first type contains an RS, a pilot, or a preamble.

In possible implementations, the header of the symbol of the first type contains an RS, a pilot, or a preamble.

In possible implementations, a position of the symbol of the first type is specified by a signaling.

In possible implementations, the header of the symbol of the first type is longer than a header of a symbol other than the symbol of the first type.

In possible implementations, the header of the symbol of the first type is a low-index portion of an input of a DFT module.

In possible implementations, the header of the symbol of the first type is a portion of the input of the DFT module indicated by an index with a value less than a first predefined index value.

In possible implementations, the header of the symbol of the first type is prior to a data portion of the symbol of the first type.

In possible implementations, the header of the symbol of the first type is a high-index portion of an input of a DFT module.

In possible implementations, the header of the symbol of the first type is a portion of the input of the DFT module indicated by an index with a value greater than a second predefined index value.

In possible implementations, the header of the symbol of the first type is subsequent to a data portion of the symbol of the first type.

In possible implementations, after switching from the sleep state to the working state in response to detecting that the header of the symbol of the first type is the predefined sequence or signaling, the processing unit 610 is further configured to detect a control channel, where the control channel includes a PDCCH, a PDCCH of at least one DCI format, or a PDCCH of at least one search space set.

In possible implementations, after switching from the sleep state to the working state in response to detecting that the header of the symbol of the first type is the predefined sequence or signaling, the processing unit 610 is further configured to start a timer if the header of the symbol of the first type is the predefined sequence or signaling, where the timer includes a timer within a duration of the working state or an inactivity timer.

When being applied to another method for data transmission, the communication apparatus may include the following. The processing unit 610 is configured to switch from a sleep state to a working state in response to detecting that a header of a symbol of a second type is a predefined sequence or signaling.

In possible implementations, a portion of the symbol of the second type other than the header has a UW DFT-S-OFDM waveform or a ZT DFT-S-OFDM waveform.

In possible implementations, the header of the symbol of the second type has a waveform other than the UW DFT-S-OFDM waveform or the ZT DFT-S-OFDM waveform.

In possible implementations, the symbol of the second type contains a common preamble.

In possible implementations, the header of the symbol of the second type contains a common preamble.

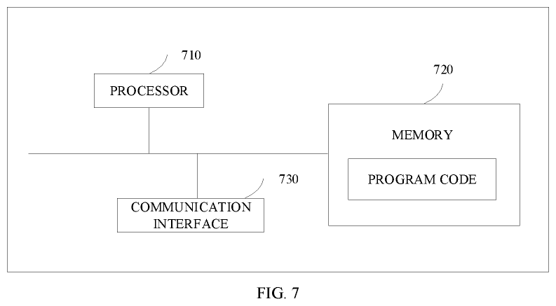

Referring to FIG. 7, FIG. 7 is a simplified schematic diagram illustrating a physical structure of a communication apparatus provided in implementations of the disclosure. The apparatus includes a processor 710, a memory 720, and a communication interface 730. The processor 710, the memory 720, and the communication interface 730 are connected via one or more communication buses.

The processor 710 is configured to support the communication apparatus to execute corresponding functions in the methods in FIGS. 2 and 5. The processor 710 may be a central processing unit (CPU), a network processor (NP), a hardware chip, or any combination thereof.

The memory 720 is configured to store program codes and the like. The memory 720 may include a volatile memory, such as a random access memory (RAM). The memory 720 may also include a non-volatile memory, such as a read-only memory (ROM), a flash memory, a hard disk drive (HDD), or a solid-state drive (SSD), or may include a combination thereof.

The communication interface 730 is configured to transmit and receive data, information, or messages, and may also be referred to as a transceiver, a transceiver circuit, and the like. For example, the communication interface 730 is configured for the terminal device to receive a symbol of a first type and the like transmitted by the access network device.

In implementations of the disclosure, when being applied to a terminal device and a method for data transmission, the processor 710 can invoke the program codes stored in the memory 720 to perform the following operations. The processor 710 invokes the program codes stored in the memory 720 to switch from a sleep state to a working state in response to detecting that a header of a symbol of a first type is a predefined sequence or signaling.

In possible implementations, the symbol of the first type has a UW DFT-S-OFDM waveform or a ZT DFT-S-OFDM waveform, and control the communication interface 730 to receive the symbol of the first type.

In possible implementations, the symbol of the first type contains an RS, a pilot, or a preamble.

In possible implementations, the header of the symbol of the first type contains an RS, a pilot, or a preamble.

In possible implementations, a position of the symbol of the first type is specified by a signaling.

In possible implementations, the header of the symbol of the first type is longer than a header of a symbol other than the symbol of the first type.

In possible implementations, the header of the symbol of the first type is a low-index portion of an input of a DFT module.

In possible implementations, the header of the symbol of the first type is a portion of the input of the DFT module indicated by an index with a value less than a first predefined index value.

In possible implementations, the header of the symbol of the first type is prior to a data portion of the symbol of the first type.

In possible implementations, the header of the symbol of the first type is a high-index portion of an input of a DFT module.

In possible implementations, the header of the symbol of the first type is a portion of the input of the DFT module indicated by an index with a value greater than a second predefined index value.

In possible implementations, the header of the symbol of the first type is behind the data portion of the symbol of the first type.

In possible implementations, after switching from the sleep state to the working state in response to detecting that the header of the symbol of the first type is the predefined sequence or signaling, the processor 710 invokes the program codes stored in the memory 720 to detect a control channel, where the control channel includes a PDCCH, a PDCCH of at least one DCI format, or a PDCCH of at least one search space set.

In possible implementations, after switching from the sleep state to the working state in response to detecting that the header of the symbol of the first type is the predefined sequence or signaling, the processor 710 invokes the program codes stored in the memory 720 to start a timer if the header of the symbol of the first type is the predefined sequence or signaling, where the timer includes a timer within a duration of the working state or an inactivity timer.

When the communication apparatus is applied to a terminal device and another method for data transmission, the processor 710 can invoke the program codes stored in the memory 720 to perform the following operations. The processor 710 invokes the program codes stored in the memory 720 to switch from a sleep state to a working state in response to detecting that a header of a symbol of a second type is a predefined sequence or signaling.

In possible implementations, a portion of the symbol of the second type other than the header has a UW DFT-S-OFDM waveform or a ZT DFT-S-OFDM waveform.

In possible implementations, the header of the symbol of the second type has a waveform other than the UW DFT-S-OFDM waveform or the ZT DFT-S-OFDM waveform.

In possible implementations, the symbol of the second type contains a common preamble.

In possible implementations, the header of the symbol of the second type contains a common preamble.

It should be noted that, in foregoing implementations, descriptions of respective implementations have their own emphases, and for parts not described in detail in a certain implementation, reference may be made to relevant descriptions of other implementations.

The steps in methods in implementations of the disclosure can be adjusted, combined, and deleted according to actual needs.

The units in processing devices in implementations of the disclosure can be combined, divided, and deleted according to actual needs.

The functions in implementations described above may be implemented in whole or in part through software, hardware, firmware, or any combination thereof. When implemented through software, the functions may be implemented in whole or in part in a form of a computer program product. The computer program product includes one or more computer instructions. When the computer program instructions are loaded and executed on a computer, processes or functions are generated in whole or in part according to implementations of the disclosure. The computer may be a general-purpose computer, a special purpose computer, a computer network, or another programmable apparatus. The computer instructions may be stored in a computer-readable storage medium, or may be transmitted from one computer-readable storage medium to another computer-readable storage medium. For example, the computer instructions may be transmitted from a website site, a computer, a server, or a data center to another website site, computer, server, or data center through a wired mode (e.g., a coaxial cable, an optical fiber, and a digital subscriber line (DSL)) or a wireless mode (e.g., infrared radiation, radio, and microwave). The computer-readable storage medium may be any available medium which a computer may access to, or a data storage device such as a server or data center that includes one or more available media integrated therein. The available medium may be a magnetic medium (e.g., a floppy disk, a memory disk, and a magnetic tape), an optical medium (e.g., a digital video disc (DVD)), or a semiconductor medium (e.g., a solid state disk (SSD)), or the like.

Finally, it should be noted that above implementations are only for illustration of the technical solutions of the disclosure rather than limitation. Although the disclosure has been described in detail with reference to foregoing implementations, those of ordinary skill in the art should understand that it is still possible to modify the technical solutions described in foregoing implementations or perform equivalent replacements for some or all of the technical features. These modifications or replacements do not make the essence of the technical solutions depart from the scope of the technical solutions of various implementations of the disclosure.

A method for data transmission and a communication apparatus are disclosed in the disclosure, with which the power consumption of data transmission can be reduced and the coexistence of different systems can be ensured.

In a first aspect, implementations of the disclosure provide a method for data transmission. The method includes: switching from a sleep state to a working state in response to detecting that a header of a symbol of a first type is a predefined sequence or signaling.

In implementations, the symbol of the first type has a unique word (UW) discrete Fourier transform spreading orthogonal frequency division multiplexing (DFT-S-OFDM) waveform or a zero tail (ZT) DFT-S-OFDM waveform.

In implementations, the header of the symbol of the first type contains a reference signal, a pilot, or a preamble.

In implementations, a position of the symbol of the first type is specified by a signaling.

In implementations, the header of the symbol of the first type is longer than a header of a symbol other than the symbol of the first type.

In implementations, the header of the symbol of the first type is a low-index portion of an input of a discrete Fourier transform (DFT) module.

In implementations, the header of the symbol of the first type is a portion of the input of the DFT module indicated by an index with a value less than a first predefined index value.

In implementations, the header of the symbol of the first type is prior to a data portion of the symbol of the first type.

In implementations, the header of the symbol of the first type is a high-index portion of an input of a DFT module.

In implementations, the header of the symbol of the first type is a portion of the input of the DFT module indicated by an index with a value greater than a second predefined index value.

In implementations, the header of the symbol of the first type is subsequent to a data portion of the symbol of the first type.

In implementations, after switching from the sleep state to the working state in response to detecting that the header of the symbol of the first type is the predefined sequence or signaling, detect a control channel, where the control channel includes a physical downlink control channel (PDCCH), a PDCCH of at least one DCI format, or a PDCCH of at least one search space set.

In implementations, after switching from the sleep state to the working state in response to detecting that the header of the symbol of the first type is the predefined sequence or signaling, start a timer if the header of the symbol of the first type is the predefined sequence or signaling, where the timer includes a timer within a duration of the working state or an inactivity timer (InactivityTimer).

In a second aspect, implementations of the disclosure provide another method for data transmission. The method includes: switching from a sleep state to a working state in response to detecting that a header of a symbol of a second type is a predefined sequence or signaling.

In implementations, a portion of the symbol of the second type other than the header has a UW DFT-S-OFDM waveform or a ZT DFT-S-OFDM waveform.

In implementations, the header of the symbol of the second type has a waveform other than the UW DFT-S-OFDM waveform or the ZT DFT-S-OFDM waveform.

In implementations, the header of the symbol of the second type contains a common preamble.

In a third aspect, implementations of the disclosure provide a communication apparatus. The apparatus includes a processing unit. The processing unit is configured to switch from a sleep state to a working state in response to detecting that a header of a symbol of a first type is a predefined sequence or signaling.

In a fourth aspect, implementations of the disclosure provide a communication apparatus. The apparatus includes a processing unit. The processing unit is configured to switch from a sleep state to a working state in response to detecting that a header of a symbol of a second type is a predefined sequence or signaling.

In a fifth aspect, implementations of the disclosure provide a communication apparatus. The apparatus includes a processor, a memory, and a user interface. The processor, the memory, and the user interface are coupled with one another. The memory is configured to store computer programs. The computer programs include program instructions. The processor is configured to invoke the program instructions to perform the method for data transmission as described in the first aspect and the second aspect.

In a sixth aspect, implementations of the disclosure provide a computer-readable storage medium. The computer-readable storage medium stores one or more instructions. The one or more instructions are configured to be loaded and executed by a processor to perform the method for data transmission as described in the first aspect and the second aspect.

In implementations of the disclosure, the terminal device switches from the sleep state to the working state in response to detecting that the header of the symbol of the first type is the predefined sequence or signaling, thereby reducing the power consumption of data transmission. The terminal device switches from the sleep state to the working state in response to detecting that the header of the symbol of the second type is the predefined sequence or signaling, thereby ensuring the coexistence of different systems.

1. A method for data transmission, comprising:
switching from a sleep state to a working state in response to detecting that a header of a symbol of a first type is a predefined sequence or signaling.

2. The method of claim 1, wherein the symbol of the first type has a unique word (UW) discrete Fourier transform spreading orthogonal frequency division multiplexing (DFT-S-OFDM) waveform or a zero tail (ZT) DFT-S-OFDM waveform.

3. The method of claim 1, wherein the header of the symbol of the first type contains a reference signal (RS), a pilot, or a preamble.

4. The method of claim 1, wherein a position of the symbol of the first type is specified by a signaling.

5. The method of claim 1, wherein the header of the symbol of the first type is longer than a header of a symbol other than the symbol of the first type.

6. The method of claim 1, wherein the header of the symbol of the first type is a low-index portion of an input of a discrete Fourier transform (DFT) module.

7. The method of claim 6, wherein the header of the symbol of the first type is a portion of the input of the DFT module indicated by an index with a value less than a first predefined index value.

8. The method of claim 6, wherein the header of the symbol of the first type is prior to a data portion of the symbol of the first type.

9. The method of claim 1, wherein the header of the symbol of the first type is a high-index portion of an input of a DFT module.

10. The method of claim 9, wherein the header of the symbol of the first type is a portion of the input of the DFT module indicated by an index with a value greater than a second predefined index value.

11. The method of claim 9, wherein the header of the symbol of the first type is subsequent to a data portion of the symbol of the first type.

12. The method of claim 1, wherein after switching from the sleep state to the working state in response to detecting that the header of the symbol of the first type is the predefined sequence or signaling, the method further comprises:
detecting a control channel, wherein the control channel comprises a physical downlink control channel (PDCCH), a PDCCH of at least one DCI format, or a PDCCH of at least one search space set.

13. The method of claim 1, wherein after switching from the sleep state to the working state in response to detecting that the header of the symbol of the first type is the predefined sequence or signaling, the method further comprises:
starting a timer, wherein the timer comprises a timer within a duration of the working state or an inactivity timer.

14-17. (canceled)

18. A communication apparatus, comprising:
a processor;
a memory; and
a user interface, wherein the processor, the memory, and the user interface are coupled with one another, the memory is configured to store computer programs, the computer programs comprise program instructions, and the processor is configured to invoke the program instructions to:
switch from a sleep state to a working state in response to detecting that a header of a symbol of a first type is a predefined sequence or signaling.

19. A non-transitory computer-readable storage medium storing one or more instructions, the one or more instructions being configured to be loaded and executed by a processor to:
switch from a sleep state to a working state in response to detecting that a header of a symbol of a first type is a predefined sequence or signaling.

20. The communication apparatus of claim 18, wherein the symbol of the first type has a unique word (UW) discrete Fourier transform spreading orthogonal frequency division multiplexing (DFT-S-OFDM) waveform or a zero tail (ZT) DFT-S-OFDM waveform.

21. The communication apparatus of claim 18, wherein the header of the symbol of the first type contains a reference signal (RS), a pilot, or a preamble.

22. The communication apparatus of claim 18, wherein a position of the symbol of the first type is specified by a signaling.

23. The communication apparatus of claim 18, wherein the header of the symbol of the first type is longer than a header of a symbol other than the symbol of the first type.

24. The communication apparatus of claim 18, wherein the header of the symbol of the first type is a low-index portion of an input of a discrete Fourier transform (DFT) module.
